(19) United States
(12) Patent Application Publication
(10) Pub. No.: US 2025/0030965 A1
(43) Pub. Date: Jan. 23, 2025

(54) DEVICE AND METHOD FOR READING OUT OF A PIXEL ARRAY IN AN IMAGE SENSOR

(71) Applicant: SAMSUNG ELECTRONICS CO., LTD., SUWON-SI (KR)

(72) Inventors: Akshaya A MUKUNDAN, Bengaluru (IN); Vishwanath Vijaykumar HIREMATH, Bengaluru (IN); Prashant Govindlal RUPAPARA, Bengaluru (IN); Takahiko INADA, Hwaseong-si (KR)

(73) Assignee: SAMSUNG ELECTRONICS CO., LTD., SUWON-SI (KR)

(21) Appl. No.: 18/778,007

(22) Filed: Jul. 19, 2024

(30) Foreign Application Priority Data
Jul. 19, 2023 (IN) 202341048509
Jul. 17, 2024 (IN) 202341048509

(51) Int. Cl. H04N 25/78; H04N 25/46

(52) U.S. Cl. CPC H04N 25/78; H04N 25/46

(57) ABSTRACT

There is provided a method for reading out a pixel array in an image sensor. The method includes determining a readout sequence based on a row offset, the row offset indicating a first set of rows and a second set of rows sharing a first output line and a second output line, reading, in a first row from the first set of rows of the pixel array, pixels corresponding to a first floating diffusion (FD) node from the first output line, and reading, in a second row from the first set of rows of the pixel array, pixels corresponding to a second floating diffusion (FD) node from the second output line at the plurality of time intervals, the first row and the second row from the first set of rows are incremented through the first set of rows based on the determined readout sequence.

### CROSS-REFERENCE TO RELATED APPLICATION

This application is based on and claims priority to Indian Provisional Patent Application No. 202341048509, filed on Jul. 19, 2023, and Indian patent application No. 202341048509, filed on Jul. 17, 2024, in the Indian Intellectual Property Office, the content of which is incorporated herein by reference in its entirety.

### BACKGROUND

The disclosure relates to image sensors, and more particularly, to a method and device for reading out a pixel array in an image sensor.

Image sensors are electronic devices that detect and capture visual information. The image sensors are commonly used in a variety of devices including, but not limited to, digital cameras, smartphones, surveillance cameras, and medical imaging equipment. Over the years, the readout of pixels in the image sensors has undergone significant advancements. Evolution in pixel readout technology has played a crucial role in improving image quality, reducing noise levels, and enhancing overall camera performance. There are various types of image sensors, such as charge-coupled devices (CCD), solid-state complementary metal-oxide-semiconductor (CMOS) sensors, etc. The solid-state CMOS sensors offer several advantages compared to other image sensors. The solid-state CMOS sensors are more compact, consume less power, and can be produced at a lower cost. Additionally, the solid-state CMOS sensors have a faster readout speed, enabling them to capture images and video with higher frame rates.

The solid-state CMOS sensors use various methods to readout an active pixel sensor (APS) array. APS arrays have high sensitivity to light and generate low noise, resulting in higher-quality images compared to other sensor technologies. The APS arrays are primarily used to capture images by converting light into electronic signals. As such, APS arrays are one of the primary components in digital cameras, smartphones, and other imaging devices. The APS array may include a Floating Diffusion (FD) node, which is used to convert the charge generated by photo-sensitive cells of the APS array into a digital signal that can be read and processed. The FD node may be shared among multiple pixels in the APS array, which allows for higher-resolution images with lower power consumption. While working with small pixel sizes and increased FD node sharing, features like conversion gain (CG) require simultaneous access to rows that are farther apart within the APS array. This is because the CG needs to manage the signal conversion and amplification effectively across a wider range of pixels to maintain image quality and sensitivity. As the simultaneous row access becomes farther apart, the image breakup artifact in moving objects becomes prominent and degrades image quality.

FIG. 1A illustrates an example scenario 100a depicting a pixel array architecture including a 2×4 shared FD node and an 8-row Vout pixel array representing a related art readout technique. FIG. 1B illustrates an example scenario 100b depicting a conversion gain (CG) in FD4 Sum binning mode representing a related art readout technique. For example, 2×4 shared FD node serves eight pixels (2 rows by 4 columns). In the 8-row Vout pixel array, the readout process may involve reading pixel data from rows spaced 8 rows apart simultaneously. For example, if row 0 and row 8 are read together, the configuration ensures that pixels in these rows are processed simultaneously. According to the related art readout technique, no perceivable image breakup issue is observed in a 2×2 shared, 8-row Vout pixel array. However, as the FD node sharing is increased to the 2×4 pixel array, the 8-row Vout pixel array with the related art readout technique fails to support a dual CG in FD4Sum binning mode as the shared rows in the CG node are accessed simultaneously. Further, in a case in which the pixels shared by a common CG node are enabled simultaneously, a summing of undesired pixels is performed. Hence, the 2×4 shared FD node-based pixel arrays use a shared 16-row Vout architecture.

FIG. 2A is a diagram 200a depicting the shared 16-row Vout line according to a related art technique. FIG. 2B is an example diagram 200b depicting the 2×4 shared FD node and a 2×8 CG node according to a related art technique-art. Moreover, FIG. 2C is a diagram 200c depicting an example of a problem such as an occurrence of a Jello effect in an image of a moving object according to a related art technique. The Jello effect is an undesired artifact that occurs in the rolling shutter-based cameras while capturing moving objects. For example, as can be seen in FIG. 2C, the issue described here may include image break-up/stagnation along with the Jello effect. Further, a detailed description related to the problem depicting staircase-like artifacts in the image of the moving object is illustrated below in conjunction with FIG. 3.

FIG. 3A is a diagram 300a depicting a related art technique for accessing rows in 2-row simultaneous readout (2RSR) full mode in an analog to digital conversion time i.e., ADC conversion time (H-time). As shown in FIG. 3A, there are 16-row shared Vout patterns for 2×4 shared FD node architecture. In 1H time in related art full 2RSR readout, 1^{st} row read is from FD0-row 0 even pixels and 2^{nd} row read is from FD4-row 16 even pixels. Thus, the simultaneously read rows are 16 rows farther apart. Similarly, in 2H time in related art full 2RSR readout, 1^{st} row read is from FD0-row 0 odd pixels and 2^{nd} row read is from FD4-row 16 odd pixels. Similarly, in 3˜4H time, row 1 and row 17 are read, and so on till all the rows 0˜31 are read. The same reading pattern is followed for full image reading. As in the related art readout technique of FIG. 3A, since row 15 is read in 31˜32H time, whereas row 16 was read in 0˜1H time, any object movement in row 0˜15 within 32H time duration would result in the staircase artifact in the resultant image. Also, since the rows are farther apart, and the time duration for the impact of the object movement is wider, the issue is more significant in the 16 Vout shared pixel array.

FIG. 3B is a diagram 300b depicting a related art technique for accessing rows in 2RSR binning mode. As shown in FIG. 3B, there are 8-row shared Vout pattern for 2×4 shared FD node architecture. In 1H time in related art binning 2RSR readout, 1^{st} row read is from binning of row 0 and row 1 of FD0, and row 4 and row 5 of FD1. Further, 2^{nd} row read is from the binning of row 8 and row 9 of FD2, and row 12 and row 13 of FD3. Since FD1 from 1^{st} row read and FD2 from 2^{nd} row read share CG1 node, the charge in FD1 and FD2 nodes are corrupted in modes requiring dual conversion gain (DCG) support along with binning. In the example scenario shown in FIG. 3B, the FD nodes get shared among the 2RSR rows while performing the DCG. Hence, it is not possible to have dual CG support for related art 2RSR binning modes in the 2×4 FD node pixel array with 8-row shared Vout architecture.

FIG. 4 illustrates a diagram 400 depicting a related art readout method in a pixel array along with row access in binning mode. The pixel array as shown in FIG. 4 includes a plurality of shared FD nodes i.e., FD0, FD1, FD2, and FD3, and a plurality of conversion gain (CG) nodes i.e., CG0 and CG1. However, only one FD node is active in the shared CG nodes. FIG. 5 is another example diagram 500 depicting a readout method in a pixel array along with row access in full mode and FD sum mode. The readout method in the pixel array may include the FD node and a CG node. The FD node may be the 2×4 sharing floating diffusion node and the CG node may be a 2×8 node shared for dual conversion gain. The readout method in the pixel array along with row access in full mode may include only one FD node active in the shared CG node. The readout method in the pixel array along with row access FD sum mode may include only one FD node active in the shared CG node.

FIG. 6 is a diagram 600 depicting a pixel readout pattern according to a related art technique. The pixel readout pattern may include the 2×4 FD node. When reading a high-resolution 50 MP image, each pixel must be read individually to maintain full resolution. In the 2×4 pixel sharing arrangement with the single FD node, simultaneous readout of these pixels is not feasible. For a horizontal 2-pixel sharing, either all even or all odd pixels can be read at a time. With two Vout lines and sufficient ADC capacity, it is possible to read even pixels from a first row and a second row, for example, the 0th row and the 16th row simultaneously. However, this setup is insufficient for reading all even pixels in both the 0th and 16th rows. While this readout pattern, aims to reduce the artifact, the drawback is unable to meet the least possible minimum or maximum integration time constraint. Consequently, while this approach enables reading even pixels from distant rows, it increases the gap between the rows read, yet maintains continuity in the readout sequence.

In view of the above described limitations of the related art readout techniques, related art readout of the tetra pixel array with 2-row simultaneous readout has a worst-case row read time difference between adjacent pixel rows, which results in image breakup and/or flicker effect while capturing the fast moving objects.

Additionally, the related art techniques for the related art APS array structure need additional dummy lines in the APS array, which are also read in order to eliminate image stagnation artifact. However, the related art techniques fail to meet the least possible min/max integration time constraint. Also, the use of additional dummy lines in the APS array results in an additional pixel array area due to the addition of dummy lines and frame per second (FPS) degradation due to dummy line readout.

Therefore, there is a need for an improved readout method that can overcome the above-mentioned problems of with the related art techniques, which includes, but is not limited to, image breakup and/or flicker effect while capturing the fast moving objects, frame per second (FPS) degradation, etc.

### SUMMARY

According to an aspect of the disclosure, there is provided a method for reading out a pixel array in an image sensor, the method including: determining a readout sequence based on a row offset, the row offset indicating a first set of rows and a second set of rows sharing a first output line and a second output line; reading, in a first row from the first set of rows of the pixel array, each of a plurality of even pixels and a plurality of odd pixels corresponding to a first floating diffusion (FD) node from the first output line at a plurality of time intervals, and reading, in a second row from the first set of rows of the pixel array, each of a plurality of even pixels and a plurality of odd pixels corresponding to a second floating diffusion (FD) node from the second output line at the plurality of time intervals, the first row and the second row from the first set of rows are incremented through the first set of rows based on the determined readout sequence; and reading, in a first row from the second set of rows of the pixel array, each of the plurality of even pixels and the plurality of odd pixels corresponding to a third FD node from the second output line at the plurality of time intervals and reading, in a second row from the second set of rows of the pixel array, each of the plurality of even pixels and the plurality of odd pixels corresponding to a fourth FD node from the first output line at the plurality of time intervals, the first row and the second row from the second set of rows are incremented through the first set of rows based on the determined readout sequence.

According to another aspect of the disclosure, there is provided a device including: an image sensor including: a pixel array; and a readout circuitry configured to: determine a readout sequence based on a row offset, the row offset indicating a first set of rows and a second set of rows sharing a first output line and a second output line; read, in a first row from the first set of rows of the pixel array, each of a plurality of even pixels and a plurality of odd pixels corresponding to a first floating diffusion (FD) node from the first output line at a plurality of time intervals, and reading, in a second row from the first set of rows of the pixel array, each of a plurality of even pixels and a plurality of odd pixels corresponding to a second floating diffusion (FD) node from the second output line at the plurality of time intervals, the first row and the second row from the first set of rows are incremented through the first set of rows based on the determined readout sequence; and read, in a first row from the second set of rows of the pixel array, each of the plurality of even pixels and the plurality of odd pixels corresponding to a third FD node from the second output line at the plurality of predefined time intervals and reading, in a second row from the second set of rows of the pixel array, each of the plurality of even pixels and the plurality of odd pixels corresponding to a fourth FD node from the first output line at the plurality of predefined time intervals, the first row and the second row from the second set of rows are incremented through the first set of rows based on the determined readout sequence.

### BRIEF DESCRIPTION OF DRAWINGS

These and other features, aspects, and advantages of the disclosure will become better understood when the following detailed description is read with reference to the accompanying drawings in which like characters represent like parts throughout the drawings, wherein:

FIG. 1A illustrates an example scenario depicting a pixel array architecture including a 2×4 shared floating diffusion (FD) node and an 8-row Vout pixel array representing a related art readout technique;

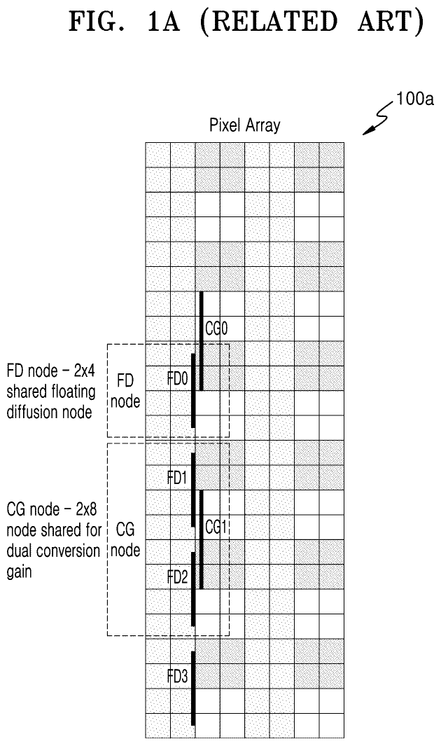

FIG. 1B illustrates an example scenario depicting a conversion gain (CG) in FD4 sum binning mode representing a related art readout technique;

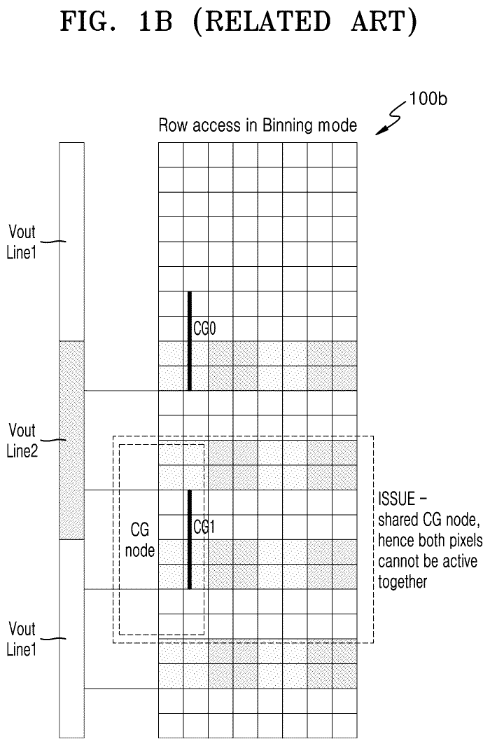

FIG. 2A is a diagram depicting the shared 16-row Vout line according to related art;

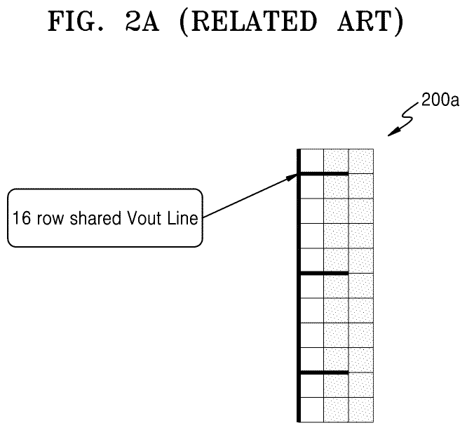

FIG. 2B is an example diagram depicting the 2×4 shared FD node and a 2×8 CG node according to related art;

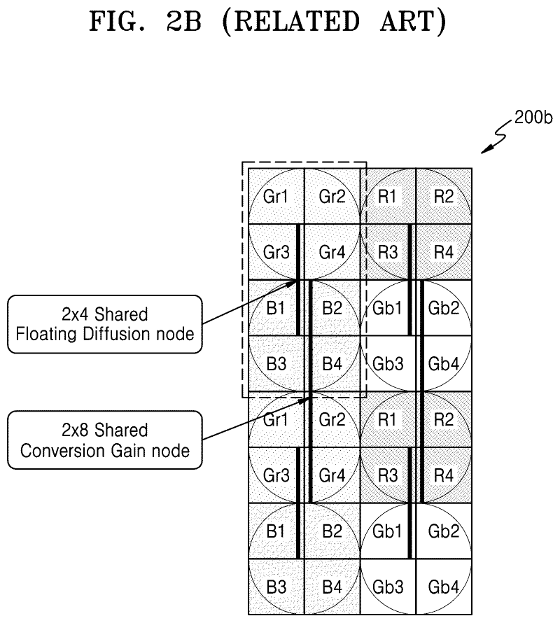

FIG. 2C is a diagram depicting an example of a problem such as an occurrence of a Jello effect in an image of a moving object according to related art;

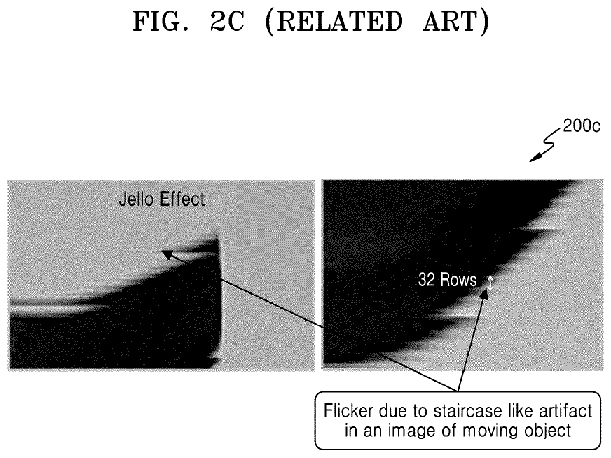

FIG. 3A is a diagram depicting a related art technique for accessing rows in two (2) row simultaneous readout (2RSR) full mode in an analog to digital conversion time;

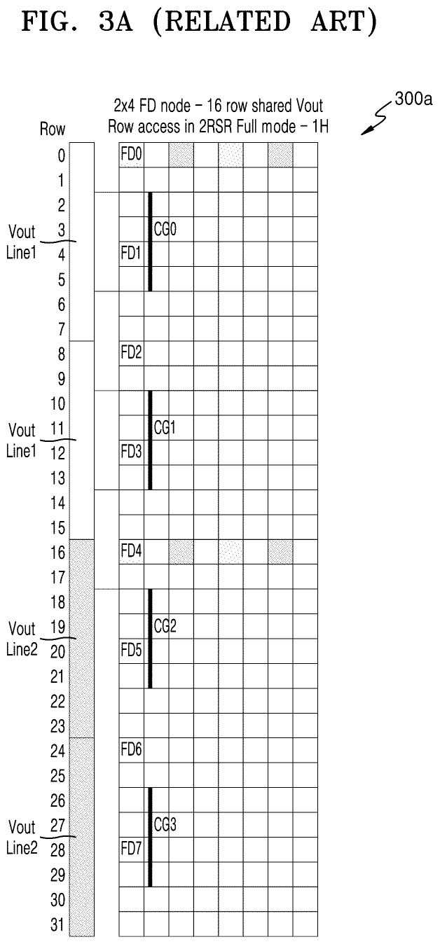

FIG. 3B is a diagram depicting a related art technique for accessing rows in 2RSR binning mode;

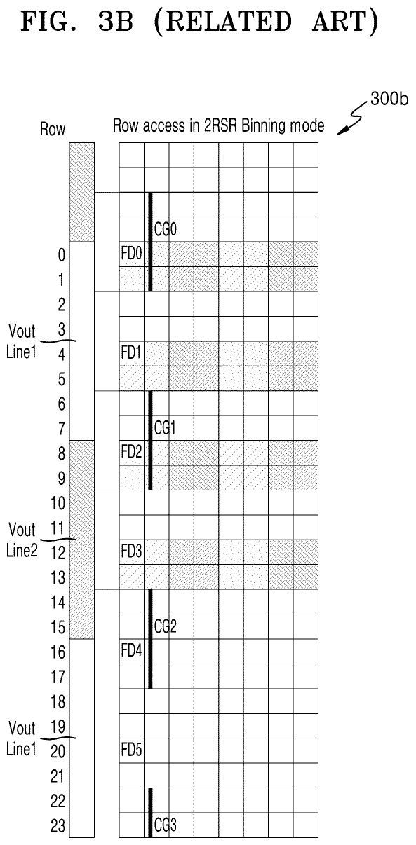

FIG. 4 illustrates a diagram depicting a related art readout method in a pixel array along with row access in binning mode;

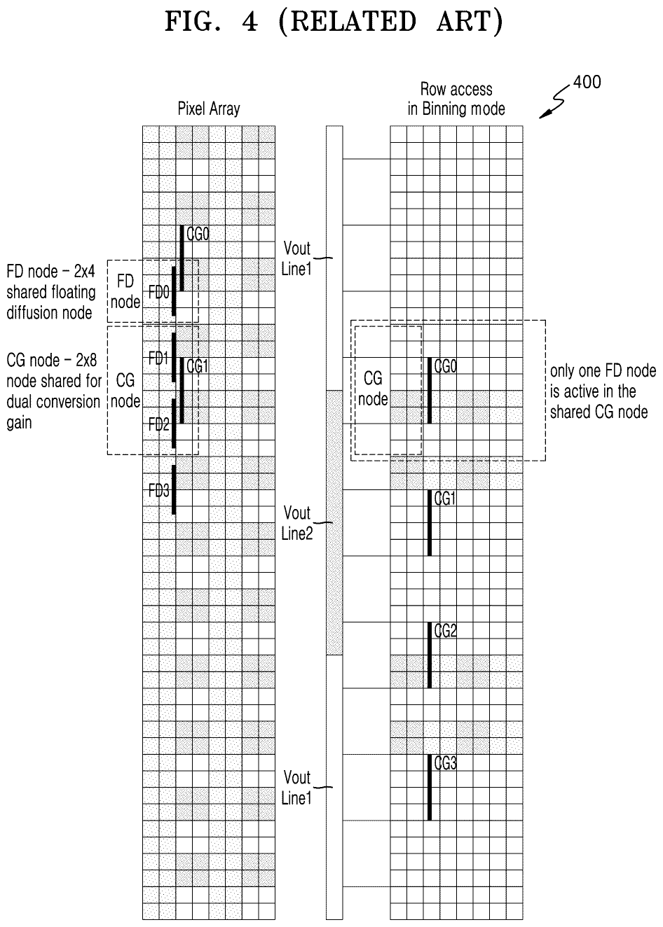

FIG. 5 is another example diagram depicting a related art readout method in a pixel array along with row access in full mode and FD sum mode;

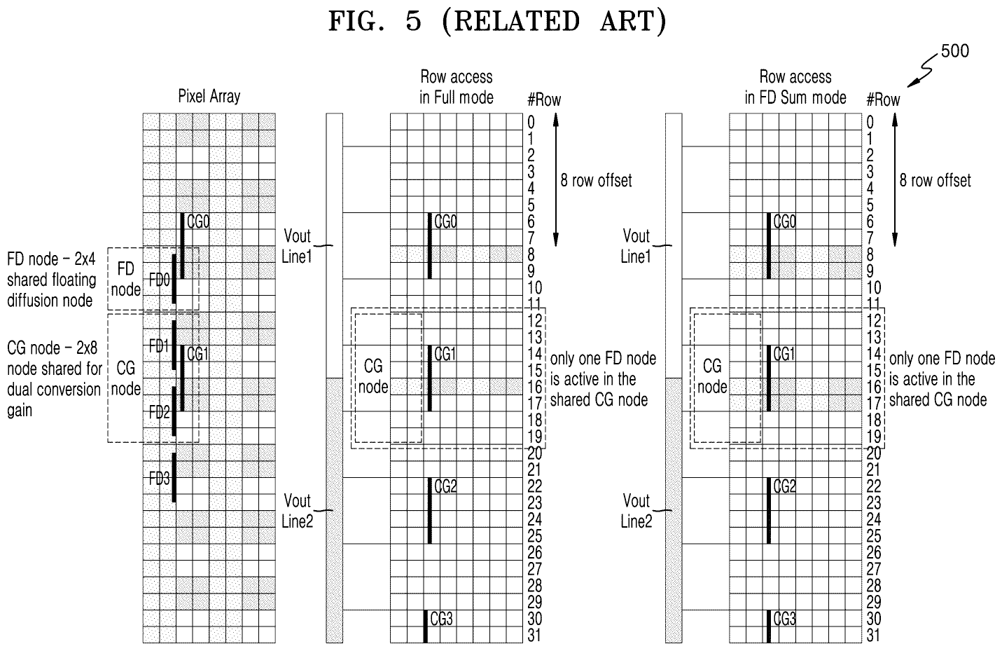

FIG. 6 is a diagram depicting a pixel readout pattern according to related art;

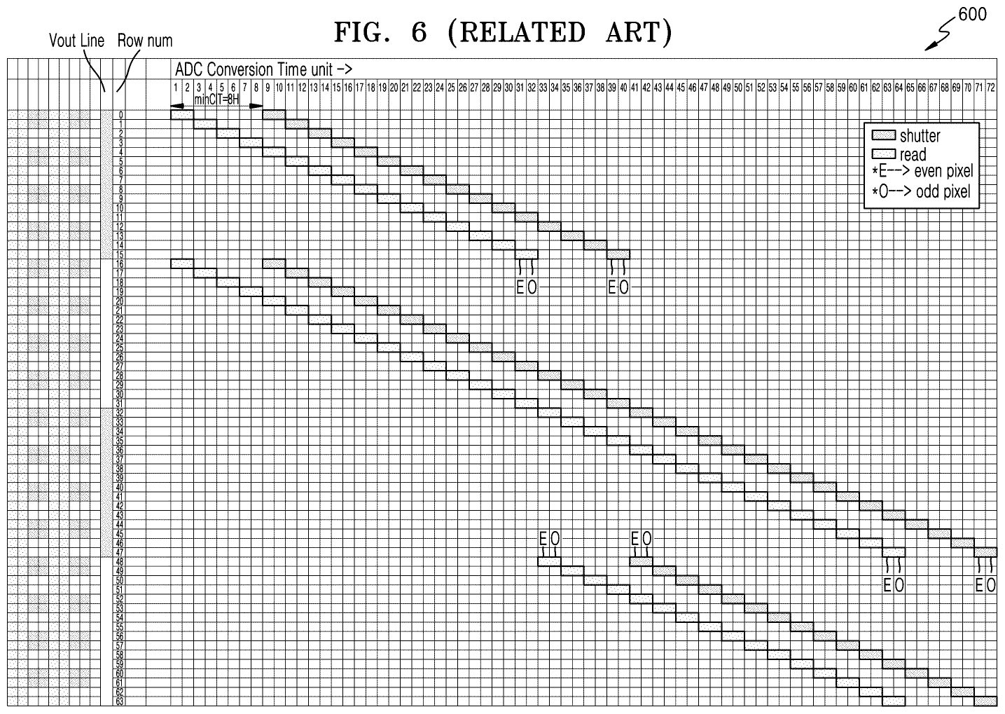

FIG. 7 is a block diagram of a device for performing the readout of a pixel array, according to one or more embodiments of the disclosure;

FIG. 8A is an example diagram depicting a method for accessing rows in two (2) row simultaneous readout (2RSR) full mode at a predetermined time interval, according to one or more embodiments of the disclosure;

FIG. 8B is an example diagram depicting a method for accessing rows in the 2RSR full mode at the predetermined time interval, according to one or more embodiments of the disclosure;

FIG. 9 is an example diagram depicting a pixel readout pattern, according to one or more embodiments of the disclosure;

FIG. 10A is a flow diagram depicting a method of resetting or shuttering rows, according to one or more embodiments of the disclosure;

FIG. 10B is a flow diagram depicting a method of reading rows, according to one or more embodiments of the disclosure; and

FIG. 11 illustrates the flowchart of a method for reading out the pixel array in an image sensor, according to one or more embodiments of the disclosure.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the structure or the construction of the device, one or more components of the device may have been represented in the drawings by conventional symbols, and the drawings may show only those specific details that are pertinent to understanding the embodiments of the disclosure so as not to obscure the drawings with details that will be readily apparent to those of ordinary skill in the art having the benefit of the description herein.

### DETAILED DESCRIPTION

To promote an understanding of the principles of the disclosure, reference will now be made to the various embodiments and specific language will be used to describe the same. It will nevertheless be understood that no limitation of the scope of the embodiments of the disclosure is thereby intended, such alterations and further modifications in the illustrated system, and such further applications of the principles of the disclosure as illustrated therein being contemplated as would normally occur to one skilled in the art.

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in another embodiment” and similar language throughout this specification may, but do not necessarily, all refer to the same embodiment.

The terms “comprises”, “comprising”, “has,” “have,” or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

According to an embodiment of the disclosure, there is provided is a pixel readout method for (n×m)-shared, N-line Vout pixel array, where ‘m’ indicates the number of rows and ‘n’ indicates the number of columns. Here, N, m and n are all natural numbers. According to an embodiment, the readout may be started with a row offset. The row offset may include an N/2 row offset. In full and floating diffusion (FD) node summed modes, the rows read may be (N/2) rows apart. The separation may be based on the N/2 row offset on a Vout line for the row access start point. The separation results in a reduction of row access time difference between adjacent rows to half compared with the related art readout technique.

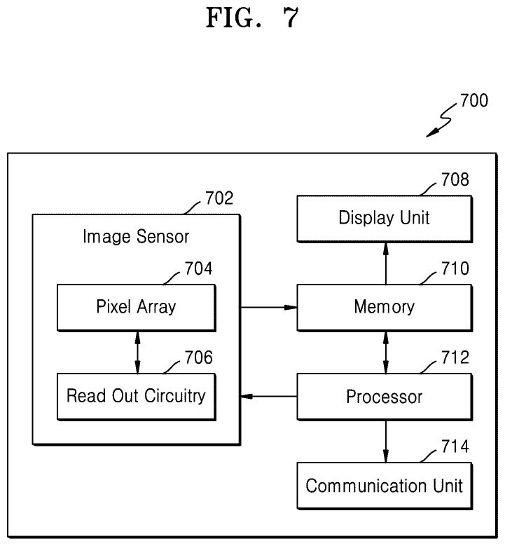

FIG. 7 is a block diagram of a device 700 for performing the readout of a pixel array 704, according to one or more embodiments of the disclosure.

The device 700 includes an image sensor 702. The device 700 may be a user device. For example, the user device may be an imaging device. The image sensor 702 may be a rolling shutter image sensor. The image sensor 702 may include the pixel array 704 and readout circuitry 706.

The pixel array 704 may include a plurality of pixels and a plurality of FD nodes. The plurality of FD nodes may correspond to the plurality of pixels. For example, the plurality of FD nodes may correspond to a plurality of even pixels, and a plurality of odd pixels. The plurality of FD nodes may include FD0, FD1, FD2, FD3, FD4, and the like. In the pixel array 704, the plurality of pixels may be arranged in a matrix. In a non-limiting example, the plurality of pixels may be arranged in a Bayer pixel array or a Tetra pixel array. A set of pixels in the plurality of pixels may share a common FD node. The FD node may be a component that temporarily stores the electrical signal generated by the plurality of pixels before it is read out. In an embodiment, the FD node may convert the charge collected by the pixel into a voltage signal, which can be processed to form an image. A number of pixels sharing the common FD node may be based on the pixel array structure.

The readout circuitry 706 may include a drive circuit and a control circuit (e.g., a controller) to perform a pixel signal readout. In an active pixel sensor (APS), each pixel may include a photodiode and a transistor that amplifies the signal before each pixel is read out. The pixel signal readout process may be one of the key factors that affects the performance and quality of image sensors. The pixel signal readout may impact various aspects of imaging, from noise levels and dynamic range to power efficiency and resolution. The readout circuitry 706 may include a signal processing circuit to perform analog-to-digital (ADC) conversion of the pixel signal readout. The readout circuitry 706 may be configured to determine a readout sequence using the row offset. The row offset may indicate a first set of rows and a second set of rows sharing a first output line and a second output line. The first output line and the second output line may be represented as Vout 1 and Vout 2. The row offset may refer to the process of staggering the readout of rows in the pixel array 704 by a plurality of rows. For instance, in an example case in which the pixel array 704 uses an N/2 row offset, it means that while reading one row from the plurality of rows, another row N/2 rows apart is read simultaneously.

Further, the readout circuitry 706 may be configured to read a first row and a second row from the first set of rows of the pixel array 704 based on the determined readout sequence. The first row may be a predefined row or a predetermined row and the second row may be a predefined row or a predetermined row. The readout circuitry 706 may read each of a plurality of even pixels and a plurality of odd pixels corresponding to a first floating diffusion (FD) node and a second FD node. The readout may be performed from the first output line and the second output line at a plurality of time intervals. The first predefined row and the second predefined row from the first set of rows may incremented through the first set of rows based on the determined readout sequence. For example, the first predefined row and the second predefined row from the second set of rows may be incremented through the plurality of rows in an increasing row order. The time intervals may be predefined or predetermined. Each of the first FD node and the second FD node may include FD0, FD1, FD2, FD3, FD4, FD5, FD6, and the like. The plurality of predefined time intervals may include a plurality of ADC conversion time. The first predefined row and the second predefined row from the first set of rows may be simultaneously read, each of the plurality of even pixels and the plurality of odd pixels is read from the first output line and the second output line. The plurality of even pixels and the plurality of odd pixels may be sequentially read from the first FD node and the second FD node. Herein, “reading a pixel” refers to reading the voltage output by the pixel on the output line (Vout1 or Vout2) connected to the pixel.

Further, the readout circuitry 706 may be configured to read the first predefined row and the second predefined row from the second set of rows of the pixel array. The readout circuitry 706 may read each of the plurality of even pixels and the plurality of odd pixels corresponding to the first FD node and the second FD node. The readout may be performed from the second output line and the first output line at the plurality of predefined time intervals. The first predefined row and the second predefined row from the second set of rows may be incremented through the first set of rows based on the determined readout sequence. For example, the first predefined row and the second predefined row from the second set of rows may be incremented through the plurality of rows in an increasing row order.

In an embodiment, the first predefined row and the second predefined row from the second set of rows are simultaneously read. For example, each of the plurality of even pixels and the plurality of odd pixels is read from the second output line and the first output line. The first predefined row and the second predefined row from the second set of rows be incremented through the plurality of rows in a monotonically increasing row order. In an embodiment, the row offset is based on the minimal distance between the first predefined row and the second predefined row from the first set of rows and the second set of rows while maintaining continuity in readout rows until an image is read.

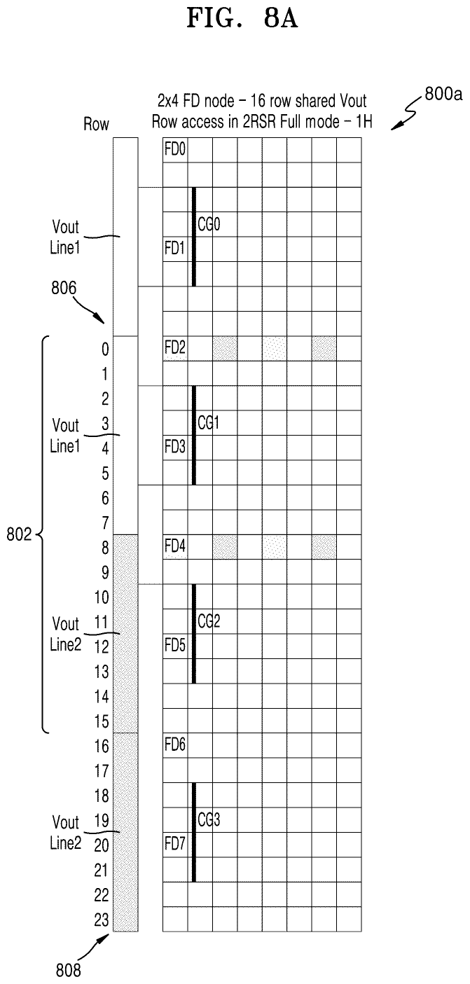

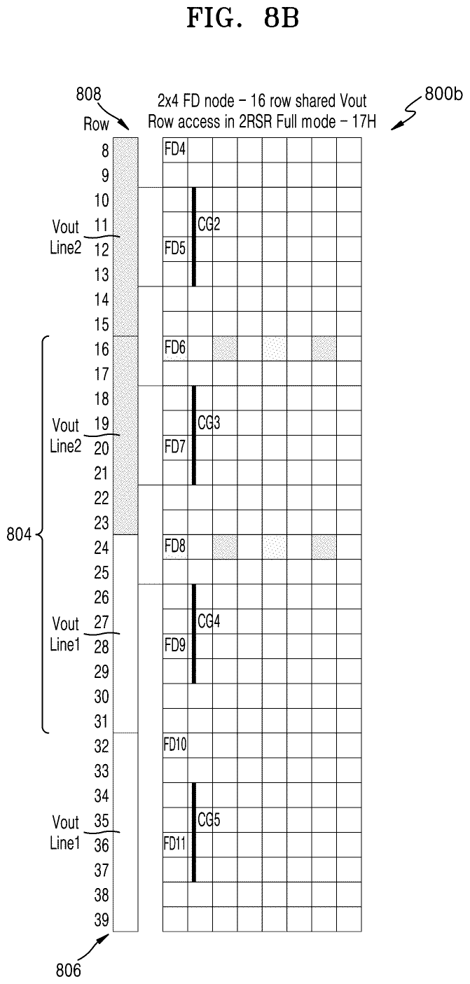

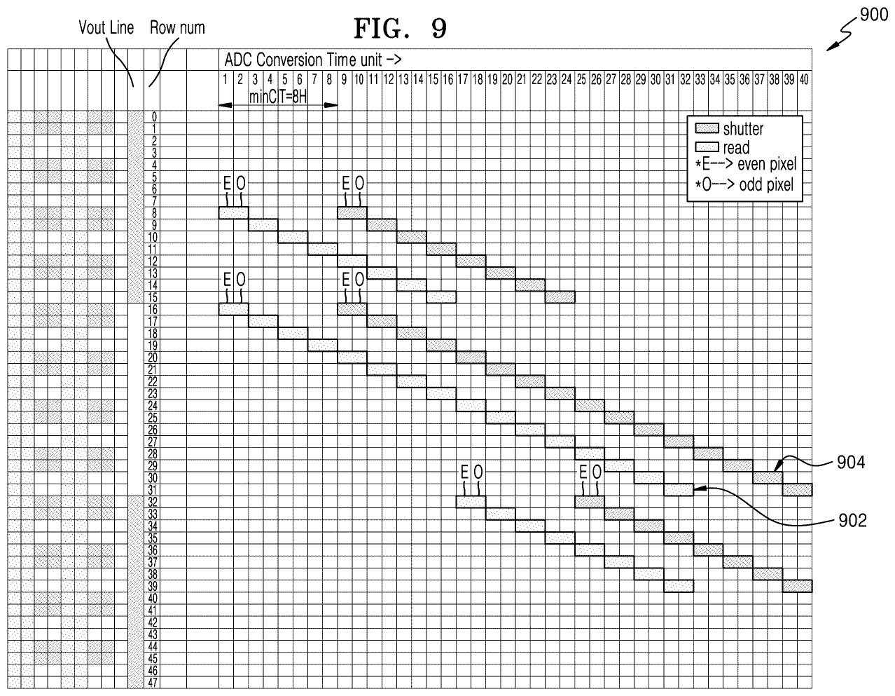

The first predefined row and the second predefined row from the first set of rows and the second set of rows may share the first output line and the second output line. In an embodiment, the first predefined row and the second predefined row from the first set of rows indicate a plurality of rows read in monotonically increasing row order. A detailed explanation of the readout architecture will be described in forthcoming paragraphs with reference to FIGS. 8A, 8B and 9.

The device 700 may further include a display unit 708, a memory 710, a processor 712, and a communication unit 714.

The processor 712 may be a single processing unit or several units, all of which could include multiple computing units. For example, the processor 712 may be implemented as a single core processor or a multi-core processor. However, the disclosure is not limited thereto, and as such, according to some embodiments, the processor 712 may be implemented as one or more microprocessors, microcomputers, microcontrollers, digital signal processors, central processing units, state machines, logic circuitries, and/or any devices that manipulate signals based on operational instructions. Among other capabilities, the processor 712 may be configured to fetch and execute computer-readable instructions and data stored in the memory 710.

The memory 710 may include one or more computer-readable storage media. According to an embodiment, the memory 710 may include non-volatile storage elements or volatile storage elements. Examples of non-volatile storage elements may include, but is not limited to, magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. However, the term “non-transitory” should not be interpreted to mean that the memory is non-movable. In certain examples, a non-transitory storage medium may store data that can, over time, change (e.g., in Random Access Memory (RAM) or cache.

The memory 710 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The display unit 708 may be configured to display the image captured using the rolling shutter image sensor 702 at a display screen of the device 700. As a non-limiting example, the display unit 708 may include, but is not limited to light emitting diode (LED), liquid crystal display (LCD), organic light emitting diode (OLED), active matrix organic light emitting diode (AMOLED), or super active matrix organic light emitting diode (S-AMOLED) screen. The display unit 708 may be of varied resolutions.

The communication unit 714 may be configured to communicate voice, video, audio, images, and/or any other data over a communication network. Further, the communication unit 714 may include a communication port or a communication interface for sending and receiving notifications on the device 700 via the communication network. The communication port or the communication interface may be a part of the processor 712 or maybe a separate component. The communication port may be created in software or maybe a physical connection in hardware. The communication port may be configured to connect with the communication network, external media, the display unit 708, or any other components in the device 700, or combinations thereof. The connection with the communication network may be a physical connection, such as a wired Ethernet connection, or may be established wirelessly as discussed above. Likewise, the additional connections with other components of the device 700 may be physical or may be established wirelessly.

Now a detailed description of the plurality of readout architectures will be described with reference to FIGS. 8A, 8B and 9.

FIG. 8A is an example diagram 800a depicting a method for accessing rows in two (2) row simultaneous readout (2RSR) full mode at a specific time interval, according to one or more embodiments of the disclosure. As can be seen from FIG. 8A, there are 16-row shared Vout pattern for 2×4 shared FD node architecture. The specific time interval may be a predetermined time interview. The predetermined time interval may include a first ADC conversion time (1H).

In an embodiment, in the 1^{st} H-time in the full 2RSR readout, a 1^{st} row of a first set of rows 802 and a 2^{nd} row of the first set of rows 802 may be read. For example, the 1^{st} row read of the first set of rows 802 may be the plurality of even pixels corresponding to the first FD node from the first output line 806 (for example, Vout Line 1) and the 2^{nd} row read of the first set of rows 802 may be the plurality of even pixels corresponding to the second FD node from the second output line 808 (for example, Vout Line 2). For example, the plurality of even pixels corresponding to the first FD node may be read sequentially during the 1^{st} row read and the plurality of even pixels corresponding to the second FD node may be read sequentially during the 2^{nd} row read. In an embodiment, the first set of rows 802 may include rows #0 to #7 that share Vout Line 1 and rows #8 to #15 that share Vout Line 2.

Further, in 2H-time in the full 2RSR readout, the 1^{st} row read of the first set of rows 802 may be the plurality of odd pixels corresponding to the first FD node from the first output line 806 and the 2^{nd} row read may be the plurality of odd pixels from the second output line 808. For example, the plurality of odd pixels corresponding to the first FD node may be read sequentially during the 1^{st} row read and the plurality of odd pixels corresponding to the second FD node may be read sequentially during the 2^{nd} row read. Furthermore, in 3˜4H time in the full 2RSR readout, row 1 and row 9 are read, and so on until all the rows 0˜15 may be read. Since row 7 is read in 15˜16H time and the row 8 may be read in 0˜1H time in this readout, each of the row differences and the object movement impact duration may be reduced to half compared to the related art readout technique.

FIG. 8B is an example diagram 800b depicting a method for accessing rows in the 2RSR full mode at the predetermined time interval, according to one or more embodiments of the disclosure. As can be seen from FIG. 8B, there are 16-row shared Vout patterns for 2×4 shared FD node architecture. In the 17H-time in the full 2RSR readout, a 1^{st} row of a second set of rows 804 and a 2^{nd} row of the second set of rows 804 may be read. For example, the 1^{st} row read of the second set of rows 804 may be the plurality of even pixels corresponding to the first FD node from the second output line 808 and the 2^{nd} row read of the second set of rows 804 may be the plurality of even pixels corresponding to the second FD node from the first output line 806. Further, in 18H-time in the full 2RSR readout, the read in the 1^{st} row of the second set of rows 804 may be the plurality of odd pixels corresponding to the first FD node from the second output line 808, and the read in the 2^{nd} row read of the second set of rows 804 may be the plurality of odd pixels corresponding to the second FD node from the first output line 806. Furthermore, in 19˜20H time in the full 2RSR readout, row 1 and row 9 are read, continuing until all rows 16˜31 are read. Additionally, in 17˜32H time in the full 2RSR readout, the 1^{st} row may be read through the second output line 808 instead of the first output line 806, and vice versa. The readout order may be followed in rows 0˜31 across 32 H-times and may be continued for the remaining rows until the full image is read. Thus, the readout method as illustrated in FIGS. 8A and 8B results in the least possible distance between simultaneously accessed rows while maintaining the continuity in the readout rows. In an embodiment, the second set of rows 804 may include rows #16 to #23 may share Vout Line 2, and rows #24 to #31 may share Vout Line 1.

FIG. 9 is an example diagram 900 depicting a pixel readout pattern, according to one or more embodiments of the disclosure. The pixel readout pattern 900 may include the 2×4 FD node. The pixel readout pattern 900 may include a first band 902, and a second band 904. The first band 902 may represent resetting or shuttering of the FD nodes and the second band 904 may represent the time at which the readout of the pixels. The pixels may include the plurality of even pixels and the plurality of odd pixels. In the pixel readout pattern 900, the readout sequence may be initiated on the output line using the row offset. In the pixel readout pattern 900, the 8^{th} row and 16^{th} row may be read together. Similarly, the readout may continue till rows 15 and 23 are read together. Thereafter, row 24 may be read along with row 32, and the readout process may continue in a similar manner until all the rows in the image sensor is read. In an example, the minimal distance between the 8^{th} row and the 16^{th} row may be obtained while maintaining continuity in readout rows until an image is read.

In an embodiment, the pixel readout process may include resetting the FD nodes and starting accumulating the charge for the predetermined time interval. The predetermined time interval may be known as the integration time. In this pixel readout pattern 900, a minimum possible integration time may be shown.

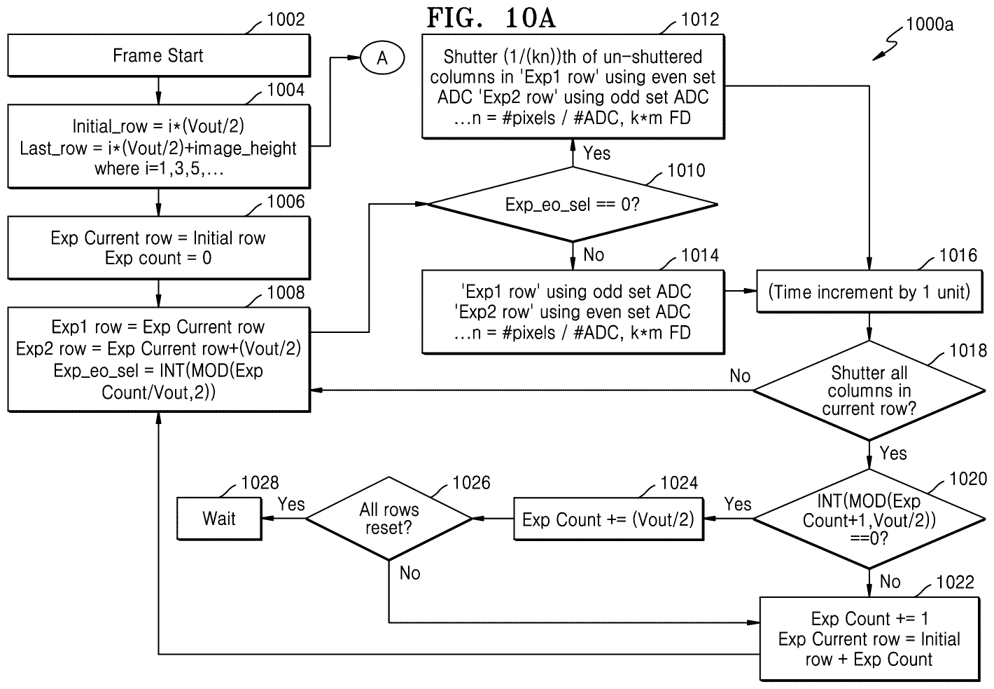

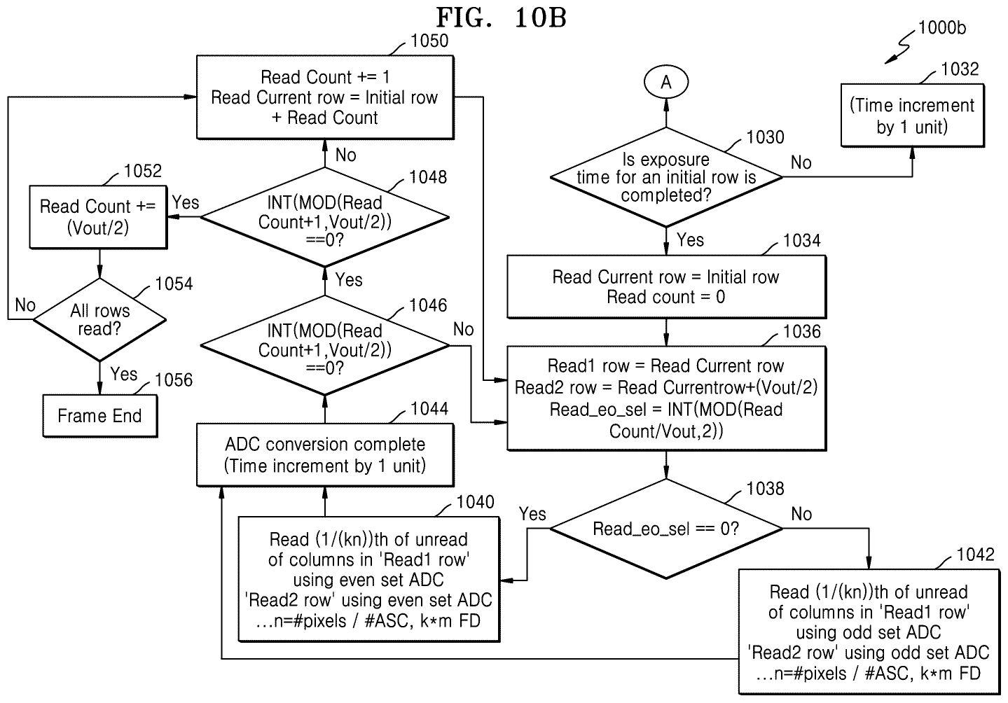

FIG. 10A is a flow diagram 1000a depicting a method of resetting or shuttering rows, according to one or more embodiments of the disclosure.

At block 1002, the method 1000a may include initiating the frame processing.

At block 1004, the method 1000a may include setting an initial row and a last row for the readout. According to an embodiment, the initial row and the last row for the readout may be set based on equation (1):

Initial_row=i*(Vout/2), Last_row=i*(Vout/2)+image_height, where i=1,3,5, . . . (1)

In equation (1), “Initial row” is an APS array row corresponding to a shutter start, “Last row” is a final row for shutter and read in the APS array, “Vout” is a number of consecutive APS array rows sharing a common readout line before switching to another readout line in the APS array, and “image height” is image size as configured by the user in terms of APS array rows. According to an embodiment, equation (1) may be used to set the first and last shutter rows based on the user requirement for image height.

At block 1006, the method 1000a may include initializing the current row for exposure and the exposure count. According to an embodiment, the current row for the exposure and the exposure count may be initialized based on equation (2):

Exp_Current_row=Initial_row, and Exp_count=0 (2)

In equation (2), “Exp_current_row” is an APS array row corresponding to an active shutter, “Initial row” is an APS array row corresponding to the shutter start, and “Exp_count” is a variable for counting the number of APS array rows that are already being shuttered. According to an embodiment, equation (2) may be used to set the shutter row for the active shutter 1 and count the number of already exposed rows in the APS array.

At block 1008, the method 1000a may include calculating the rows for exposure and the exposure selection value. According to an embodiment, the rows for exposure and the exposure selection value (“Exp_eo_sel”) may be calculated based on equation (3):

Exp1_row=Exp_Current_row,Exp2_row=Exp_Current_row+(Vout/2),Exp_eo_sel=INT(MOD(Exp_count/Vout,2)) (3)

In equation (3), “Exp1_row” is an APS array row corresponding to an active shutter 1, “Exp2_row” is an APS array row corresponding to an active shutter 2, “Exp_current_row” is a APS array row corresponding to an active shutter, “Exp_eo_sel” is a variable to indicate that Vout rows have been shuttered when set to 1, “INT” is a mathematical function, which outputs only integer values for an input, and “MOD”, which is a mathematical function which outputs modulo values for an input. According to an embodiment, equation (3) may be used to keep track of active shutter rows for shutter 1 and shutter 2.

At block 1010, the method 1000a may include evaluating the exposure selection value. For example, the method may include determining whether Exp_eo_sel==0. If the condition is YES (e.g., Exp_eo_sel==0), at block 1012, the method 1000a may include shuttering (1/(kn))th of un-shuttered columns in ‘Exp1 row’ using equation (4) as illustrated below:

‘Exp1row’ using even set ADC, ‘Exp2 row’ using an odd set ADC . . . n=#pixels/#ADC,k*m FD (4)

According to an embodiment, equation (4) may indicate that while the active shutter 1 may use the even ADC's to readout image data, and the active shutter 2 may use the odd ADC's to readout image data.

If the condition is NO, at block 1014, the method 1000a may include shuttering (1/(kn))th of un-shuttered columns in ‘Exp1 row’ using equation (5) as illustrated below:

‘Exp1 row’ using odd set ADC,‘Exp2 row’ using even set ADC . . . n=#pixels/#ADC,k*m FD (5)

According to an embodiment, equation (5) may indicate that while the active shutter 1 may use the odd ADC's to readout image data, and the active shutter 2 may use the even ADC's to readout image data.

At block 1016, the method 1000a may include a time increment by 1 unit.

At block 1018, the method 1000a may include determining whether the shuttering of all columns in a current row is completed. If the condition is NO, at block 1008, the method 1000a is continued. For example, the method 1000a may return to block 1008. If the condition is YES, at block 1020, the method 1000a may include determining whether INT (MOD (ExpCount+1,Vout/2))==0. For example, block 1020 may determine whether Integer modulo 2 (Exposure Count+1, Vout sharing length/2))==0. Further, if the condition is NO, at block 1022, the method 1000a may include incrementing the variable Exp Count by 1, setting Exp Current row to be equal to Initial row plus the value of Exp Count based on equation (6) as illustrated below:

Exp Count+=1,Exp Current row=Initial row+Exp Count (6)

In equation (6), “Exp_current_row” is an APS array row corresponding to an active shutter, “Initial row” is an APS array row corresponding to the shutter start, and “Exp_count” is a variable for counting the number of APS array rows that are already being shuttered. According to an embodiment, equation (6) may be used to increment the shutter 1 and 2 row values.

If the condition is YES, at block 1024, the method 1000a may include incrementing the variable exp count by half of the value of Vout based on the equation (7) as illustrated below:

Exp Count+=(Vout/2) (7)

In equation (7), “Exp_count” is a variable for counting the number of APS array rows that are already being shuttered and “Vout” is number of consecutive APS array rows sharing a common readout line before switching to another readout line in the APS array. According to an embodiment, equation (7) may be used to increment the shutter row count by Vout/2 value on every Vout/2 row reset by shutter 1.

At block 1026, the method 1000a may include determining whether all rows are reset. If the condition is YES, at block 1028, the method 1000a may include waiting for the next frame. If the condition is NO, at block 1022, the method 1000a is continued. For example, the method 1000a may return to block 1008.

FIG. 10B is a flow diagram 1000b depicting a method of reading rows, according to one or more embodiments of the disclosure.

At block 1030, the method 1000b may include determining whether the exposure time for an initial row is completed. If the condition is NO, at block 1032, the method 1000b may include a time increment by one unit. If the answer is YES, at block 1034, a read current row is set to be equal to the initial row, and a read count is equal to the zero.

At block 1036, the method 1000b may include reading the first row to be read is equal to the current row, and the second row to be read is equal to the current row plus (Vout/2), and determining read even or odd selection. For example, the read even or odd selection may be based on equation (8) as illustrated below:

Read1 row=Read Current row

Read2 row=Read Current row+(Vout/2)

Read_eo_sel=INT(MOD(Read Count/Vout,2)) (8)

In equation (8), “Read1_row” is an APS array row corresponding to active readout 1, “Read2_row” is an APS array row corresponding to active readout 2, “Read_eo_sel” is a variable to indicate that Vout rows have been read when set to 1, “INT” is a mathematical function, which outputs only integer values for an input, “MOD” is a mathematical function, which outputs modulo values for an input, and “Vout” is a number of consecutive APS array rows sharing a common readout line before switching to another readout line in the APS array. According to an embodiment, equation (8) may be used to keep track of active read rows for readout 1 and readout 2.

At block 1038, the method 1000b may include determining whether the read even or odd selection indicates a read even or a read odd. For example, the read even or odd selection may be based on equation (9) as illustrated below:

Read_eo_sel==0? (9)

In equation (9), “Read_eo_sel” is a variable to indicate that Vout rows have been read when set to 1. According to an embodiment, equation (9) may be used to indicate that ‘Vout’ rows have been read when set to 1.

If the condition is YES (e.g., selection is even), at block 1040, read (1/(kn))th of unread columns in ‘Read 1 row’ using the even set ADC and ‘Read 2 row’ using the even set ADC. If the condition is NO (e.g., selection is odd), at block 1042, read (1/(kn))th of unread columns in ‘Read1 row’ using the odd set ADC, and ‘Read 2 row’ using the odd set ADC.

At block 1044, the method 1000b may include the ADC conversion complete (Time increment by 1 unit).

At block 1046, the method 1000b may include determining reading of all columns in the current row is completed. If the condition is NO, the method continues at block 1036. For example, if all the columns in the current row are not read, the method returns to block 1036. If the condition is YES, at block 1048, the method may include determining whether an integer part of the remainder is divided by Vout/2 equals zero based on the equation (10)) as illustrated below:

INT(MOD(Read Count+1,Vout/2))==0? (10)

In equation (10), “INT” is a mathematical function, which outputs only integer values for an input, “MOD” is a mathematical function, which outputs modulo values for an input, and “Vout” is a number of consecutive APS array rows sharing a common readout line before switching to another readout line in the APS array. According to an embodiment, equation (10) may be used to define a mathematical function to check if Vout/2 rows have been readout by active readout 1.

Further, if the condition is NO, at block 1050, the method 1000b may include updating the current row being read to be equal to the initial row plus the updated read count based on the equation (11) as illustrated below:

read count+=1, read current row=Initial row+read count (11)

In equation (11), “Initial row” is an APS array row corresponding to a shutter start. According to an embodiment, equation (11) may be used to increment the readout 1 and 2 row values.

If the condition is YES, at block 1052, increasing the read count by half of the value of Vout based on the equation (12) as illustrated below:

Read Count+=(Vout/2) (12)

According to an embodiment, equation (12) may be used to increment the read row count by Vout/2 value on every Vout/2 row readout by active readout 1.

At block 1054, method 1000b includes determining whether all rows are read. If the answer is YES, at block 1056, the method 1000b may include the frame end. If the answer is NO, at block 1050, the method 1000b includes updating the current row being read to be equal to the initial row plus the updated read count based on the equation (11). Thereafter, the method proceeds to block 1036, at which, the method 1000b includes reading the first row to be read is equal to the current row, and the second row to be read is equal to the current row plus (Vout/2).

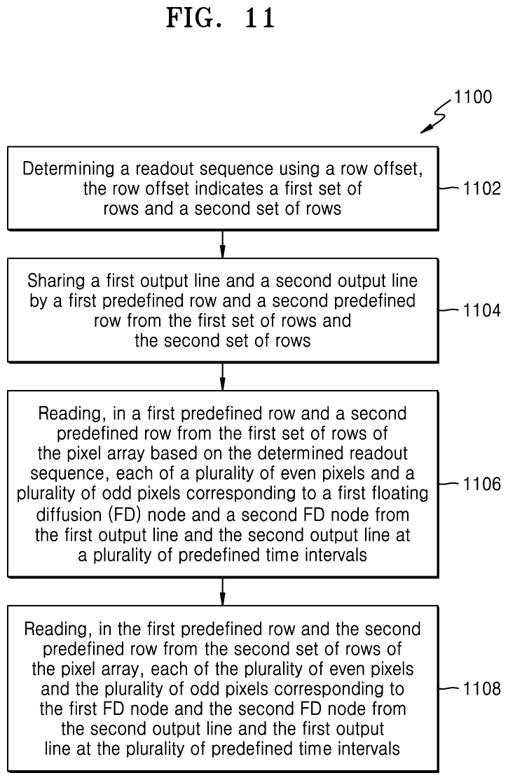

FIG. 11 illustrates the flowchart of method 1100 for reading out the pixel array in an image sensor, according to one or more embodiments of the disclosure. The method 1100 may be performed by the readout circuitry 706 illustrated in FIG. 7. However, the disclosure is not limited to thereto, and as such, according to another embodiment, the method 1100 may be implemented in another device, such as, a processor. For the sake of brevity, structural and operational features of the device that are already explained in the description of FIGS. 7, 8, 9, 10A and 10B, and as such, are not explained in detail in the description of FIG. 11.

In operation 1102, the method 1100 may include determining the readout sequence using the row offset. For example, the row offset indicates the first set of rows and the second set of rows.

In operation 1104, the method 1100 may include sharing the first output line and the second output line by the first predefined row and the second predefined row from the first set of rows and the second set of rows.

In operation 1106, the method 1100 may include reading, in the first predefined row and the second predefined row from the first set of rows of the pixel array based on the determined readout sequence, each of the plurality of even pixels and the plurality of odd pixels corresponding to the first FD node and the second FD node from the first output line and the second output line at the plurality of predefined time intervals.

In operation 1108, the method 1100 may include reading, in the first predefined row and the second predefined row from the second set of rows of the pixel array, each of the plurality of even pixels and the plurality of odd pixels corresponding to the first FD node and the second FD node from the second output line and the first output line at the plurality of predefined time intervals.

According to an embodiment, the method 1100, the method may include selecting the row offset such that the distance between the first predefined row and the second predefined row from the first set of rows and the second set of rows is reduced while maintaining continuity in readout rows until an image is read. For example, the row offset may be set to N/2 row offset.

According to an aspect of the disclosure, the method may provide various technical advantages and benefits, including, but not limited to, mitigating the image breakup and/or flicker effect while capturing fast-moving objects in full, FD node summed, and binned modes effectively. According to an aspect of the disclosure, the method may include serial readout of all pixels in the shared FD node, and as such, there is provided a minimum integration time of (n×m) ADC conversion time units (least possible). Further, due to the reduction of the row gap to (N/2) between simultaneously accessed rows, the memory requirement to buffer the ADC outputs is almost half compared to a related art readout technique.

According to an aspect of the disclosure, since additional dummy line access is not necessary, the readout process according to one or more embodiments retain the FPS as in a related art readout technique. Moreover, the readouts as per the methods according to one or more embodiments of the disclosure are easily scalable to pixel arrays of various color patterns such as Bayer pattern, tetra pattern, Nona pattern, Hexa pattern, etc.

While specific language has been used to describe the embodiments of the disclosure, any limitations arising on account thereto, are not intended. As would be apparent to a person in the art, various working modifications may be made to the method in order to implement the inventive concept as described herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method for reading out a pixel array in an image sensor, the method comprising:
determining a readout sequence based on a row offset, the row offset indicating a first set of rows and a second set of rows sharing a first output line and a second output line;
reading, in a first row from the first set of rows of the pixel array, each of a plurality of even pixels and a plurality of odd pixels corresponding to a first floating diffusion (FD) node from the first output line at a plurality of time intervals, and reading, in a second row from the first set of rows of the pixel array, each of a plurality of even pixels and a plurality of odd pixels corresponding to a second floating diffusion (FD) node from the second output line at the plurality of time intervals, the first row and the second row from the first set of rows are incremented through the first set of rows based on the determined readout sequence; and
reading, in a first row from the second set of rows of the pixel array, each of the plurality of even pixels and the plurality of odd pixels corresponding to a third FD node from the second output line at the plurality of time intervals and reading, in a second row from the second set of rows of the pixel array, each of the plurality of even pixels and the plurality of odd pixels corresponding to a fourth FD node from the first output line at the plurality of time intervals, the first row and the second row from the second set of rows are incremented through the first set of rows based on the determined readout sequence.

2. The method as claimed in claim 1, wherein the row offset is based on a minimal distance between the first row and the second row from the first set of rows and the second set of rows while maintaining continuity in readout rows until an image is read.

3. The method as claimed in claim 1, wherein the first row and the second row from the first set of rows and the second set of rows share the first output line and the second output line.

4. The method as claimed in claim 1, wherein the first row and the second row from the first set of rows are simultaneously read, and
wherein each of the plurality of even pixels and the plurality of odd pixels corresponding to the first row from the first set of rows is read through the first output line and each of the plurality of even pixels and the plurality of odd pixels corresponding to the second row from the second set of rows is read through the second output line.

5. The method as claimed in claim 1, wherein the first row and the second row from the second set of rows are simultaneously read, and
wherein each of the plurality of even pixels and the plurality of odd pixels is read from the second output line (808) and the first output line (806).

6. The method as claimed in claim 1, wherein the plurality of even pixels and the plurality of odd pixels are sequentially read from the first FD node and the second FD node.

7. A device comprising:
an image sensor comprising:
a pixel array; and
a readout circuitry configured to:
determine a readout sequence based on a row offset, the row offset indicating a first set of rows and a second set of rows sharing a first output line and a second output line;
read, in a first row from the first set of rows of the pixel array, each of a plurality of even pixels and a plurality of odd pixels corresponding to a first floating diffusion (FD) node from the first output line at a plurality of time intervals, and reading, in a second row from the first set of rows of the pixel array, each of a plurality of even pixels and a plurality of odd pixels corresponding to a second floating diffusion (FD) node from the second output line at the plurality of time intervals, the first row and the second row from the first set of rows are incremented through the first set of rows based on the determined readout sequence; and
read, in a first row from the second set of rows of the pixel array, each of the plurality of even pixels and the plurality of odd pixels corresponding to a third FD node from the second output line at the plurality of predefined time intervals and reading, in a second row from the second set of rows of the pixel array, each of the plurality of even pixels and the plurality of odd pixels corresponding to a fourth FD node from the first output line at the plurality of predefined time intervals, the first row and the second row from the second set of rows are incremented through the first set of rows based on the determined readout sequence.

8. The device as claimed in claim 7, wherein the row offset is based on a minimal distance between the first row and the second row from the first set of rows and the second set of rows while maintaining continuity in readout rows until an image is read.

9. The device as claimed in claim 7, wherein the first row and the second row from the first set of rows and the second set of rows share the first output line and the second output line.

10. The device as claimed in claim 7, wherein the first row and the second row from the first set of rows are simultaneously read, and
wherein each of the plurality of even pixels and the plurality of odd pixels corresponding to the first row from the first set of rows is read through the first output line and each of the plurality of even pixels and the plurality of odd pixels corresponding to the second row from the second set of rows is read through the second output line.

11. The device as claimed in claim 7, wherein the first row and the second row from the second set of rows are simultaneously read, and
wherein each of the plurality of even pixels and the plurality of odd pixels is read from the second output line (808) and the first output line (806).

12. The device as claimed in claim 7, wherein the plurality of even pixels and the plurality of odd pixels are sequentially read from the first FD node and the second FD node.
